(19) United States
(12) Patent Application Publication
(10) Pub. No.: US 2022/0254231 A1
(43) Pub. Date: Aug. 11, 2022

(54) ELECTRONIC GAMING DEVICE WITH SKILL-BASED INTERACTION MECHANISM AFTER RNG-BASED OUTCOME DETERMINATION

(71) Applicant: Aristocrat Technologies Australia Pty Limited, North Ryde (AU)

(72) Inventor: Nicholas Bennett, Manly Vale (AU)

(73) Assignee: Aristocrat Technologies Australia Pty Limited, North Ryde (AU)

(21) Appl. No.: 17/584,242

(22) Filed: Jan. 25, 2022

(30) Foreign Application Priority Data
Feb. 9, 2021 (AU) 2021900305
Sep. 28, 2021 (AU) 2021240152

(51) Int. Cl. G07F 17/32; G07F 17/34

(52) U.S. Cl. CPC G07F 17/3262; G07F 17/34; G07F 17/3244

(57) ABSTRACT

Innovations in implementing a skill-based interaction mechanism after random number generator (“RNG”)-based outcome determination in an electronic gaming device are described herein. For example, after RNG-based outcome determination, objects may be displayed on a touchscreen display of the electronic gaming device. A given object may be associated with one or more functions to be carried out upon interaction with the object (e.g., selection of the object by the user on the touchscreen display). For example, upon selection of the object, a function associated with the object is carried out to change display of the object or generate an additional outcome using the RNG.

### CROSS REFERENCE TO RELATED APPLICATION

This application claims priority to Australian Pat. App. No. 2021900305, filed Feb. 9, 2021, the disclosure of which is hereby incorporated by reference. This application also claims priority to Australian Pat. App. No. 2021240152, filed Sep. 28, 2021, the disclosure of which is hereby incorporated by reference.

### FIELD

The present application relates to a gaming device and a method of operating a gaming device.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In many games, a player may qualify for secondary games or bonus rounds by attaining a certain winning combination or triggering event in the base game. Secondary games provide an opportunity to win additional game instances, credits, awards, jackpots, progressives, etc. Awards from any winning outcomes are typically added back to the credit balance and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for ready identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (“RNG”) to randomly determine the outcome of each game. The game is designed to return a certain percentage of the amount wagered back to the player (RTP=return to player) over the course of many plays or instances of the game. The RTP and randomness of the RNG are critical to ensuring the fairness of the games and are therefore highly regulated. Upon initiation of play, the RNG randomly determines a game outcome and symbols are then selected which correspond to that outcome. Notably, some games may include an element of skill on the part of the player and are therefore not entirely random.

### SUMMARY

In summary, the detailed description presents innovations in implementing a skill-based interaction mechanism after random number generator (“RNG”)-based outcome determination in an electronic gaming device. After RNG-based outcome determination, objects may be displayed on a touchscreen display of the electronic gaming device, where the objects are associated with functions to be carried out upon a user interacting with the objects (e.g., selecting the objects on the touchscreen display). Upon interaction with an object, one or more functions associated with the object can, for example, change display of the object, generate an additional outcome using the RNG, and/or award an amount of credits or other prize to the user. The innovations described herein include, but are not limited to, innovations recited in the claims and in the section entitled “example embodiments.” The gameplay mechanics described herein, which combine skill-based interactions with RNG-based outcome determination, increase user engagement and interaction with the electronic gaming device. These innovations also provide different tools for managing volatility and RTP in a computationally effective way when integrating a skill-based interaction mechanism with RNG-based outcome determination in an electronic gaming device.

For example, there is disclosed a gaming device and a method of operating a gaming device where an animation of a win celebration incorporates additional functionality such as an award of an additional prize to the prize being celebrated.

As another example, a disclosed gaming device comprises a display, a credit input mechanism operable to establish credits on the gaming device, meters configured for monitoring credits established via the credit input mechanism and changes to the established credits due to play of the gaming device, a random number generator, a player input for operation by a player to input a wager from the established credits and to initiate a play of a game, a processor, and memory storing game program code. The processor executes the game program code stored in the memory responsive to initiation of the play of the game by player input. The processor also executes the game program code to initiate a win celebration in response to a celebration condition being met, and control the display during the win celebration by displaying an animation of a plurality of objects superimposed on underlying game image elements, wherein, in at least some win celebrations, at least one of the objects is associated with a function to be carried out by the processor.

As another example, there is also disclosed a method of operating a gaming device comprising a display, a credit input mechanism operable to establish credits on the gaming device, meters configured for monitoring credits established via the credit input mechanism and changes to the established credits due to play of the gaming device, a random number generator, a player input for operation by a player to input a wager from the established credits and to initiate a play of a game, and a processor. The method comprises initiating, by the processor, a win celebration in response to a celebration condition being met, and controlling, by the processor, the display during the win celebration to display an animation of a plurality of objects superimposed on underlying game image elements, wherein, in at least some win celebrations, at least one of the objects is associated with a function to be carried out by the processor.

The foregoing and other objects, features, and advantages of the invention will become more apparent from the following detailed description, which proceeds with reference to the accompanying figures.

### BRIEF DESCRIPTION OF THE DRAWINGS

FIG. 1 is an exemplary diagram showing several EGMs networked with various gaming related servers.

FIG. 2 is a block diagram showing various functional elements of an exemplary EGM.

FIG. 3 illustrates an example reel strip layout.

FIG. 4 is a flow chart of a symbol selection method.

FIGS. 5 to 8 are example screen displays.

FIGS. 9A and 9B illustrate a symbol transition between different states.

FIGS. 10A and 10B illustrate a symbol transition between different states.

FIGS. 11A and 11B illustrate a symbol transition between different states.

FIGS. 12A, 12B and 12C illustrate a symbol transition between different states.

FIGS. 13 and 14 are example screen displays of a gamble feature user interface.

### DETAILED DESCRIPTION

The detailed description presents innovations in implementing a skill-based interaction mechanism after RNG-based outcome determination in an electronic gaming device. The electronic gaming device may have a touchscreen display or other type of display. After RNG-based outcome determination, objects may be shown on the display. A given object may be associated with one or more functions to be carried out upon a user interacting with the object (e.g., selecting the object), to change how the object is displayed, to generate an additional outcome using the RNG, and/or to award an amount of credits or other prize to the user. The gameplay mechanics described herein, which combine skill-based interactions with RNG-based outcome determination, increase user engagement with the electronic gaming device. In particular, by providing a way to interact with objects after RNG-based outcome determination, the gameplay mechanic provides the player some control over how the outcome is rendered and/or supplemented. These innovations also provide different tools for managing volatility and RTP in a computationally effective way when integrating a skill-based interaction mechanism with RNG-based outcome determination in an electronic gaming device, while also improving usability of the electronic gaming device and enhancing the user experience.

For example, this disclosure relates to improvements to EGMs to incorporate different modes of play, additional interactions and improvements to EGM user interfaces. In one aspect, a win celebration is provided that incorporates additional functionality. In another aspect, a smart pay table is implemented. In another aspect, an improved user interface is provided that enables an alternative gamble feature.

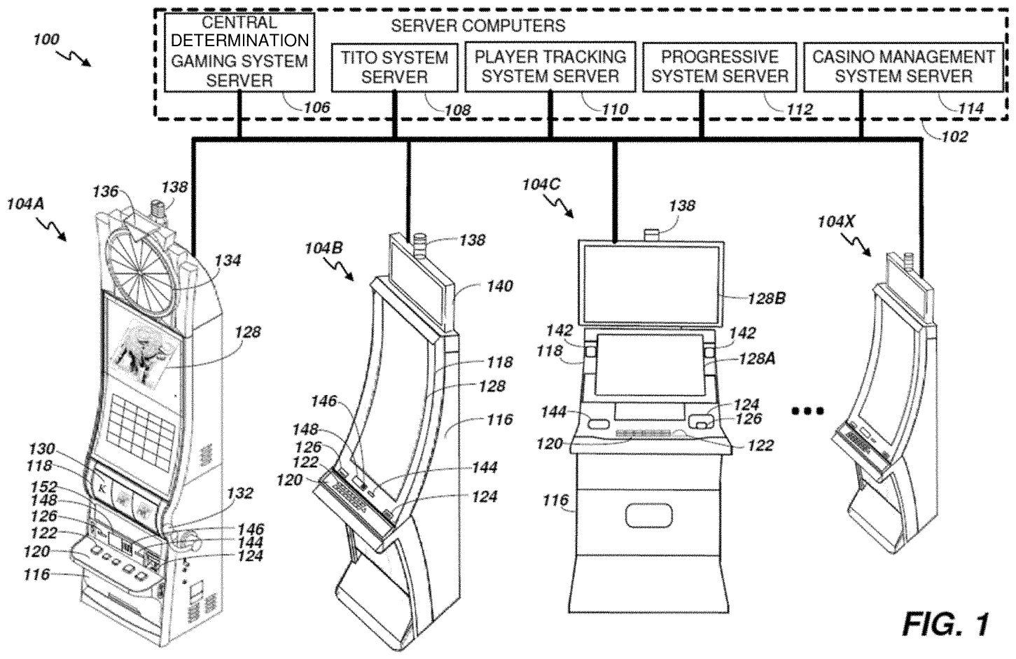

FIG. 1 illustrates several different models of EGMs which may be networked to various gaming related servers. The present invention can be configured to work as a system 100 in a gaming environment including one or more server computers 102 (e.g., slot servers of a casino) that are in communication, via a communications network, with one or more gaming devices 104A-104X (EGMs, slots, video poker, bingo machines, etc.). The gaming devices 104A-104X may alternatively be portable and/or remote gaming devices such as, but not limited to, a smartphone, a tablet, a laptop, or a game console.

Communication between the gaming devices 104A-104X and the server computers 102, and among the gaming devices 104A-104X, may be direct or indirect, such as over the Internet through a website maintained by a computer on a remote server or over an online data network including commercial online service providers, Internet service providers, private networks, and the like. In other embodiments, the gaming devices 104A-104X may communicate with one another and/or the server computers 102 over RF, cable TV, satellite links and the like.

In some embodiments, server computers 102 may not be necessary and/or preferred. For example, the present invention may, in one or more embodiments, be practiced on a stand-alone gaming device such as gaming device 104A, gaming device 104B or any of the other gaming devices 104C-104X. However, it is typical to find multiple EGMs connected to networks implemented with one or more of the different server computers 102 described herein.

The server computers 102 may include a central determination gaming system server 106, a ticket-in-ticket-out (“TITO”) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door 116 which provides access to the interior of the cabinet. Gaming device 104A typically includes a button area or button deck 120 accessible by a player that is configured with input switches or buttons 122, an access channel for a bill validator 124, and/or an access channel for a ticket printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The reels 130 are independently spun and stopped to show a set of symbols within the gaming display area 118 which may be used to determine an outcome to the game. In embodiments where the reels are mechanical, mechanisms can be employed to implement greater functionality. For example, the boundaries of the gaming display area boundaries of the gaming display area 118 may be defined by one or more mechanical shutters controllable by a processor. The mechanical shutters may be controlled to open and close, to correspondingly reveal and conceal more or fewer symbol positions from the mechanical reels 130. For example, a top boundary of the gaming display area 118 may be raised by moving a corresponding mechanical shutter upwards to reveal an additional row of symbol positions on stopped mechanical reels. Further, a transparent or translucent display panel may be overlaid on the gaming display area 118 and controlled to override or supplement what is displayed on one or more of the mechanical reel(s).

In many configurations, the gaming machine 104A may have a main display 128 (e.g., video display monitor) mounted to, or above, the gaming display area 118. The main display 128 can be a high-resolution LCD, plasma, LED, or OLED panel which may be flat or curved as shown, a cathode ray tube, or other conventional electronically controlled video monitor.

In some embodiments, the bill validator 124 may also function as a “ticket-in” reader that allows the player to use a casino issued credit ticket to load credits onto the gaming device 104A (e.g., in a cashless ticket (“TITO”) system). In such cashless embodiments, the gaming device 104A may also include a “ticket-out” printer 126 for outputting a credit ticket when a “cash out” button is pressed. Cashless TITO systems are well known in the art and are used to generate and track unique bar-codes or other indicators printed on tickets to allow players to avoid the use of bills and coins by loading credits using a ticket reader and cashing out credits using a ticket-out printer 126 on the gaming device 104A. In some embodiments a ticket reader can be used which is only capable of reading tickets. In some embodiments, a different form of token can be used to store a cash value, such as a magnetic stripe card.

In some embodiments, a player tracking card reader 144, a transceiver for wireless communication with a player's smartphone, a keypad 146, and/or an illuminated display 148 for reading, receiving, entering, and/or displaying player tracking information is provided in EGM 104A. In such embodiments, a game controller within the gaming device 104A can communicate with the player tracking server system 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some embodiments, the information panel(s) 152 may be implemented as an additional video display.

Gaming devices 104A have traditionally also included a handle 132 typically mounted to the side of main cabinet 116 which may be used to initiate game play.

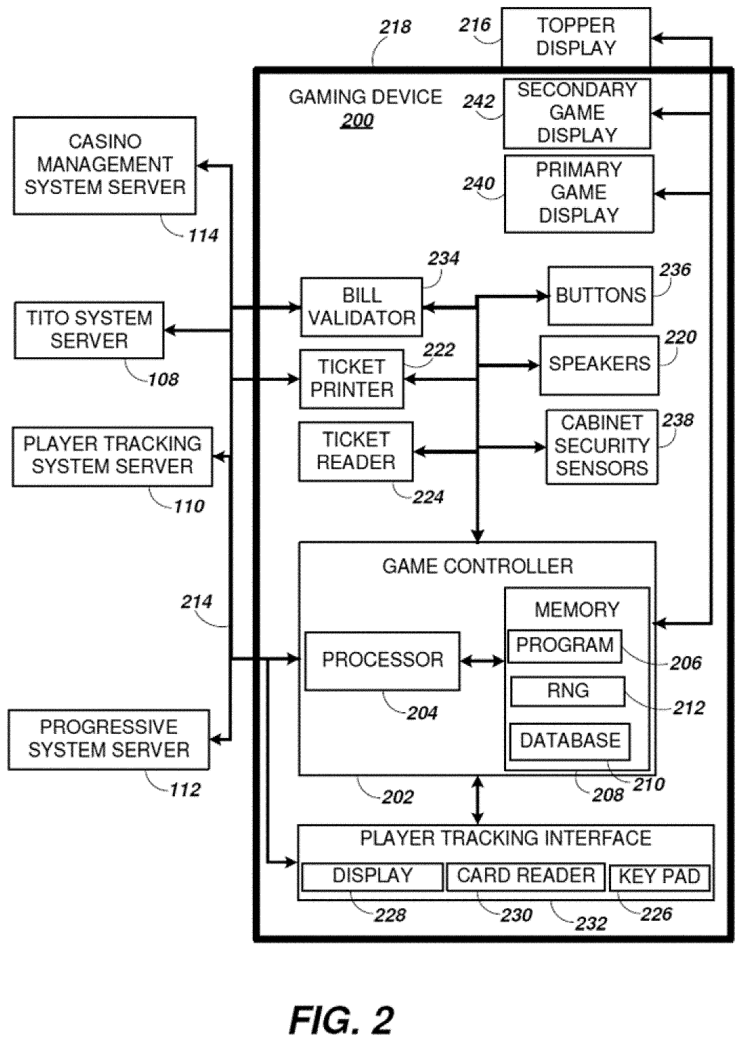

Many or all the above-described components can be controlled by circuitry (e.g., a gaming controller) housed inside the main cabinet 116 of the gaming device 104A, the details of which are shown in FIG. 2.

Note that not all gaming devices suitable for implementing embodiments of the present invention necessarily include top wheels, top boxes, information panels, cashless ticket systems, and/or player tracking systems. Further, some suitable gaming devices have only a single game display that includes only a mechanical set of reels and/or a video display, while others are designed for bar counters or table tops and have displays that face upwards.

An alternative example gaming device 104B illustrated in FIG. 1 is the Arc™ model gaming device manufactured by Aristocrat® Technologies, Inc. Note that where possible, reference numerals identifying similar features of the gaming device 104A embodiment are also identified in the gaming device 104B embodiment using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some embodiments, topper screen 140 may also or alternatively be used to display progressive jackpot prizes available to a player during play of gaming device 104B.

Example gaming device 104B includes a main cabinet 116 including a main door 118 which opens to provide access to the interior of the gaming device 104B. The main or service door 118 is typically used by service personnel to refill the ticket-out printer 126 and collect bills and tickets inserted into the bill validator 124. The door 118 may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the landscape display 128A may have a curvature radius from top to bottom, or alternatively from side to side. In some embodiments, display 128A is a flat panel display. Main display 128A is typically used for primary game play while secondary display 128B is typically used for bonus game play, to show game features or attraction activities while the game is not in play or any other information or media desired by the game designer or operator.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2 is a block diagram depicting exemplary internal electronic components of a gaming device 200 connected to various external systems. All or parts of the example gaming device 200 shown could be used to implement any one of the example gaming devices 104A-X depicted in FIG. 1. The games available for play on the gaming device 200 are controlled by a game controller 202 that includes one or more processors 204 and a game that may be stored as game software or a program 206 in a memory 208 coupled to the processor 204. The memory 208 may include one or more mass storage devices or media that are housed within gaming device 200. Within the mass storage devices and/or memory 208, one or more databases 210 may be provided for use by the program 206. A random number generator (“RNG”) 212 that can be implemented in hardware and/or software is typically used to generate random numbers that are used in the operation of game play to ensure that game play outcomes are random and meet regulations for a game of chance. In some embodiments, the random number generator 212 is a pseudo-random number generator.

Alternatively, a game instance (i.e., a play or round of the game) may be generated on a remote gaming device such as a central determination gaming system server 106 (not shown in FIG. 2 but see FIG. 1). The game instance is communicated to gaming device 200 via the network 214 and then displayed on gaming device 200. Gaming device 200 may execute game software, such as but not limited to video streaming software that allows the game to be displayed on gaming device 200. When a game is stored on gaming device 200, it may be loaded from a memory 208 (e.g., from a read only memory (“ROM”)) or from the central determination gaming system server 106 to memory 208. The memory 208 may include RAM, ROM or another form of storage media that stores instructions for execution by the processor 204.

The gaming device 200 may include a topper display 216 or another form of a top box (e.g., a topper wheel, a topper screen, etc.) which sits above main cabinet 218. The gaming cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. The player tracking interface 232 may include a keypad 226 for entering information, a player tracking display 228 for displaying information (e.g., an illuminated or video display), a card reader 230 for receiving data and/or communicating information to and from media or a device such as a smartphone enabling player tracking. Ticket printer 222 may be used to print tickets for a TITO system server 108. The gaming device 200 may further include a bill validator 234, buttons 236 for player input, cabinet security sensors 238 to detect unauthorized opening of the cabinet 218, a primary game display 240, and a secondary game display 242, each coupled to and operable under the control of game controller 202.

Gaming device 200 may be connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

Gaming devices, such as gaming devices 104A-104X, 200, are highly regulated to ensure fairness and, in many cases, gaming devices 104A-104X, 200 are operable to award monetary awards (e.g., typically dispensed in the form of a redeemable voucher). Therefore, to satisfy security and regulatory requirements in a gaming environment, hardware and software architectures are implemented in gaming devices 104A-104X, 200 that differ significantly from those of general-purpose computers. Adapting general purpose computers to function as gaming devices 200 is not simple or straightforward because of: 1) the regulatory requirements for gaming devices 200, 2) the harsh environment in which gaming devices 200 operate, 3) security requirements, 4) fault tolerance requirements, and 5) the requirement for additional special purpose componentry enabling functionality of an EGM. These differences require substantial engineering effort with respect to game design implementation, hardware components and software.

When a player wishes to play the gaming device 200, he/she can insert cash or a ticket voucher through a credit input mechanism such as a coin acceptor (not shown) or bill validator 234 to establish a credit balance on the gamine machine. The credit balance is used by the player to place wagers on instances of the game and to receive credit awards based on the outcome of winning instances. The credit balance is decreased by the amount of each wager and increased upon a win. The player can add additional credits to the balance at any time. The credit balance may be stored in a meter in memory 208 (or in a separate hardware meter). In some embodiments, memory 208 implements a credit meter to monitor to the credit balance and has a win meter that monitors any amounts won during any game instance(s) resulting from the wager. The balance of the win meter is transferred to the credit meter prior at the conclusion of the game instances. The player may also optionally insert a loyalty club card into the card reader 230. In some embodiments, the loyalty club card may also act as a credit input mechanism, by allowing a player to transfer funds from a centrally stored balance in order to establish a credit balance. During the game, the player views the game outcome on the game displays 240, 242. Other game and prize information may also be displayed.

When the player is done, he/she cashes out the credit balance (typically by pressing a cash out button to receive a ticket from the ticket printer 222). The ticket may be “cashed-in” for money or inserted into another machine to establish a credit balance for play.

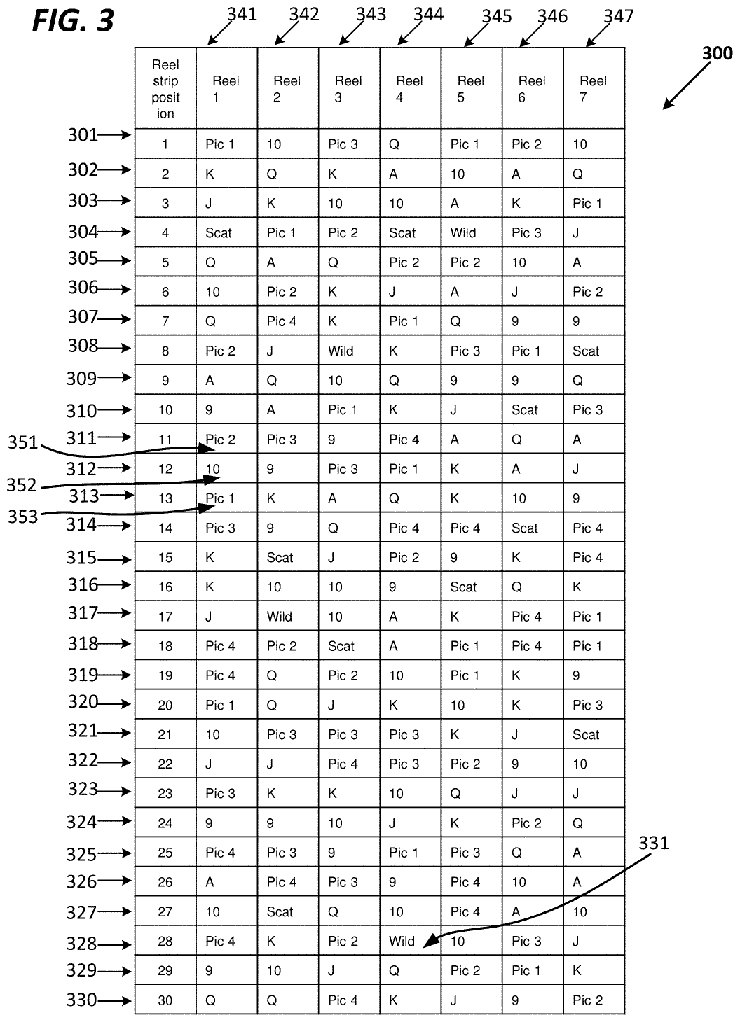

FIG. 3 illustrates an example of a set 300 of seven reel strips 341, 342, 343, 344, 345, 346, 347. In the example, each reel strip has thirty reel strip positions 301-330. Each reel strip position of each reel has a symbol. For example, a “Wild” symbol 331 occupies the twenty-eighth reel strip position 328 of the fourth reel 344. Other reels strips to those illustrated in FIG. 3 can be used, for example, reel strips where two or more wild symbols are placed at consecutive reel strip positions of a reel strip. In other examples, the reel strips could have between 30 and 100 reel strip positions. The actual lengths of the game reel strips depend on factors such as the number of wild symbols (in general, the more wilds there are, the longer the reel strip needs to be to maintain the target RTP), and volatility (in general, the higher the prize value is, the longer the reel strip needs to be to lower the hit rate to maintain the target RTP).

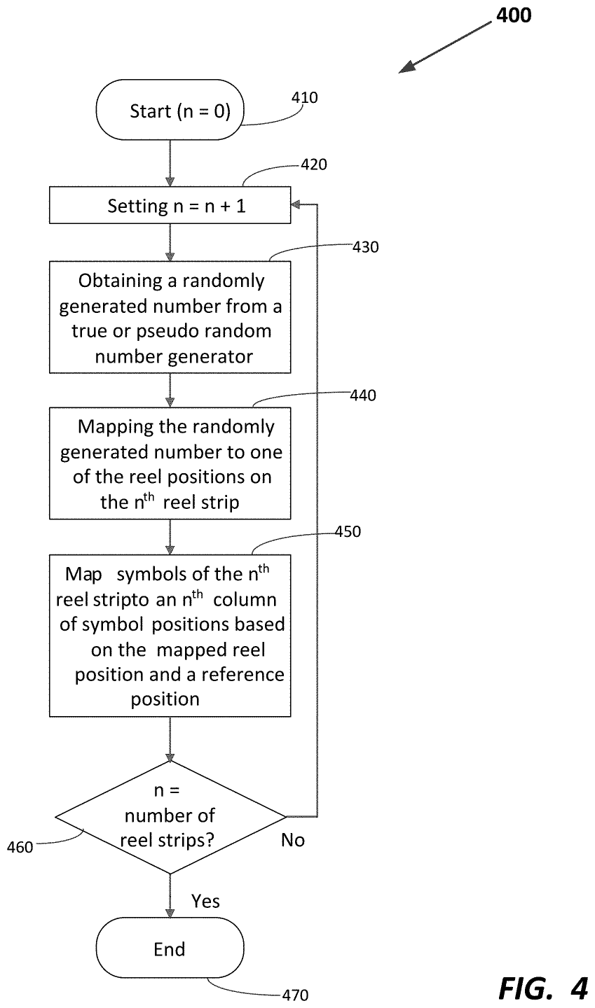

FIG. 4 is a flow chart of a method 400 carried out by the processor 204 to select symbols from reel strips. At step 410, the processor 204 starts the process of selecting symbols with a counter (n) set at zero as symbols have not yet been selected from any reel strips. At step 420, the processor 204 increments the counter. In the first iteration, the counter is set to 1 to reflect that symbols are to be selected from a first reel strip. At step 430, the processor obtains a randomly generated number from a true or pseudo random number generator 212. At step 440 the processor maps the generated number to one of the reel positions of the n^{th} reel strip. In the first iteration, this is the first reel strip. To map the generated number to one of the reel positions, the possible values that can be returned from the RNG 212 are divided into ranges and associated with specific ones of the reel positions in memory 208. In one example, these ranges are stored as a look-up table. In one example, the ranges are each the same size so that each of the reel strip positions has the same chance of been selected. In other examples, the ranges may be arranged to weight the relative chances of selecting specific reel strip positions. The reel strips may be of different lengths.

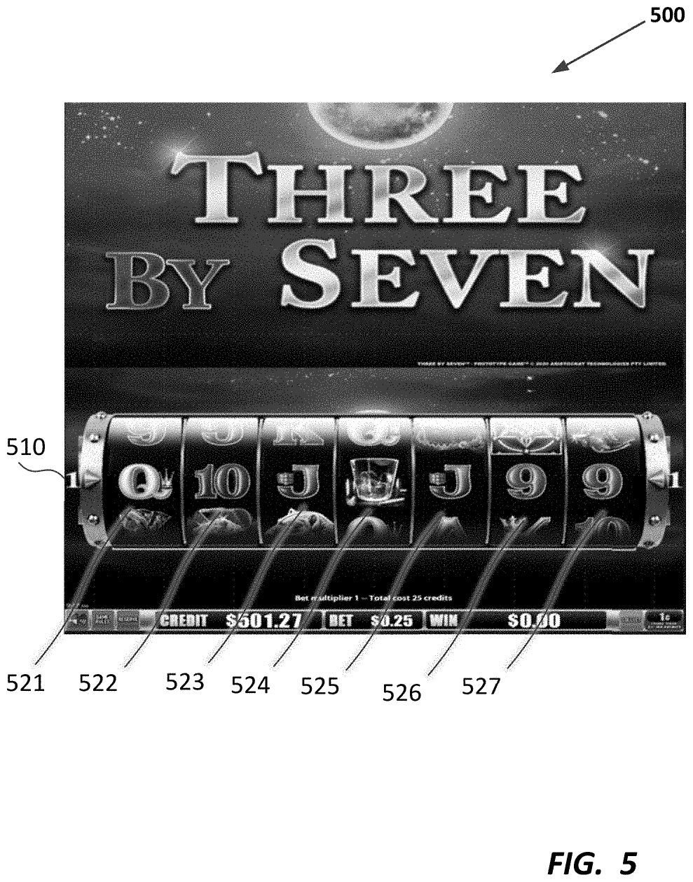

At step 450, the processor 204 maps symbols of the n^{th} reel strip to an n^{th} symbol display positions based on the mapped reel position and a reference position. In this example, only one symbol from each reel strip forms part of the game outcome that will be evaluated on single win line 510. Accordingly, as shown in example screen display 500 of FIG. 5, the reference position is the central position 521-527 of the symbol positions of each column of symbol positions. In this example, the selected reel position (and hence the symbol at this position) is mapped to the central symbol position of a column. In an example, there are two other symbol positions immediately above and below the central positions at which parts of the symbols at two neighboring reel strip positions are displayed, that is they are mapped to the partial symbol positions above and below the central symbol position 521-527. That is, there is in effect a column of symbol positions comprising the central symbol position 521-527 and the two partial symbol positions above and below the central symbol position.

Referring to the example reel strips of FIG. 3, if the value returned by the RNG 212 is mapped to reel position 312, then for the first reel strip 341, “Pic 1” symbol 353 is mapped to a bottom symbol position and will be partially displayed, “10” symbol 352 is mapped to central symbol position 521 and will form part of the game outcome, and “Pic 2” symbol 351 is mapped to a top symbol position and will be partially displayed.

At step 460, the processor 204 determines whether symbols have been selected for all of the reel strips, and if not the processor 204 reverts to step 420 and iterates through steps 430, 440 and 450 until it is determined at step 460 that symbols have been selected from all n reel strips and mapped to all n columns of symbol positions after which the symbol selection process ends 470. Different numbers of symbols may be mapped to different numbers of symbol positions. For example, in other examples, there may be three completely displayed symbol positions that are all part of the game outcome.

After the symbols of all reel strips have been mapped to symbol position, the processor 204 controls display 240 to display them at the symbol positions.

After the symbols are displayed, the processor 204 evaluates the displayed symbols on the win line 510 based on a pay table stored in the memory in order to determine whether there are any winning combinations of symbols. In the embodiment, the processor 204 also determines a whether to display a dynamic pay table and the composition of the pay table display to reflect one or more parts of the pay table in order to present contextually relevant pay table information.

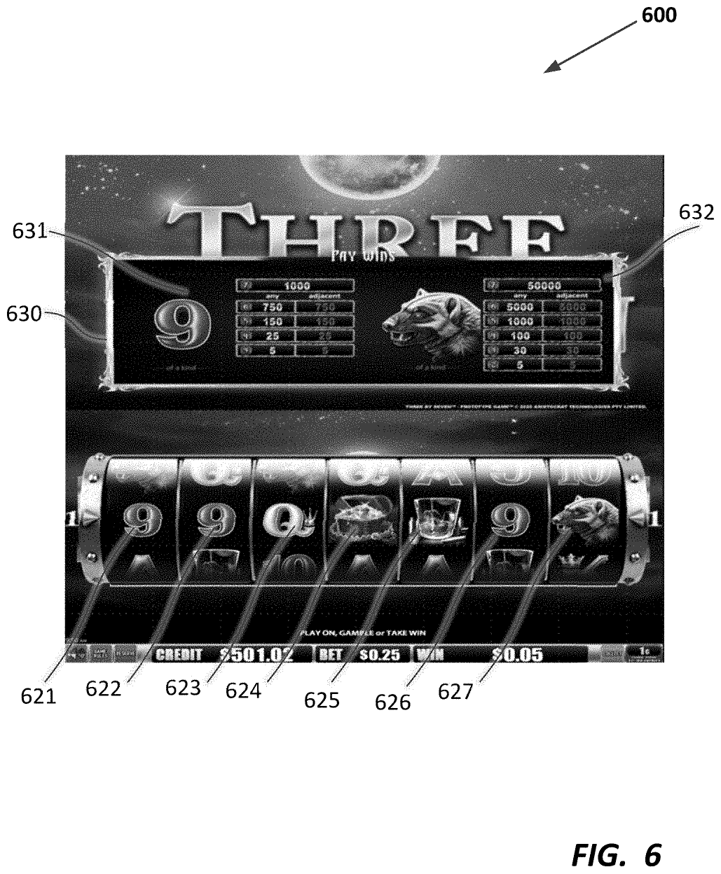

Referring to example screen display 600 of FIG. 6, there is shown a dynamic pay table display 630. In the example dynamic pay table display 630 it is composed of a first portion 631 corresponding the “9” symbol and a second portion 632 corresponding to “Wolf” symbol each of which details the pay tables available for the respective symbols.

As will be observed from FIG. 6, each pay table has a first, left-hand column for pays for symbols in any symbol position and a second, right-hand column for pays for symbols in adjacent symbol positions. In this example, the right-hand column is greyed-out to indicate that pays of that type are not concurrently active. The top prize for seven symbols is common to both pays based on any position and adjacent symbol positions because it is the maximum amount that can be achieved in either case. The pays for the “9” symbol in any position as shown in first portion 631 are summarized in Table 1.

TABLE 1

| Number of Symbols | Prize Amount (Credits) |
|---|---|
| 7 | 1000 |
| 6 | 750 |
| 5 | 150 |
| 4 | 25 |
| 3 | 5 |

The pays for the “Wolf” symbol in any position as shown in second portion 632 are summarized in Table 2.

TABLE 2

| Number of Symbols | Prize Amount (Credits) |
|---|---|
| 7 | 50000 |
| 6 | 5000 |
| 5 | 1000 |
| 4 | 100 |
| 3 | 30 |
| 2 | 5 |

In the example of FIG. 6, the processor displays a dynamic pay table 630 having two portions 631, 632 that are contextually relevant. The first portion is displayed by processor 204 in order that the player is informed about both about the pay for the three “9” symbols at symbol positions 621,622 and 626 and what win amounts were available for other winning combinations of “9” symbols. That is, the pay table indicates that “9” symbols at symbol positions 621,622 results a win amount of 5 credits for three “9” symbols and, for example, 25 credits would have been won for four “9” symbols.

The second portion 632 is displayed by processor 204 because there is one “Wolf” symbol at symbol position 627 and, as shown by Table 2, a second “Wolf” symbol would have resulted in a pay of 5 credits. The second portion is contextually relevant in that it informs the player of a pay that could have resulted from one or more additional “Wolf” symbols. That is, the “Wolf” symbol at symbol position 627 is not part of a winning combination symbols as it is one symbol fewer than the number of symbols required to form a winning combination of symbols.

In some examples, the processor 204 may implement a process to select between pay table information to display where the selected symbols make additional portions of the pay table relevant. For example, in a scenario where there was a pay for two of the “Treasure Chest” symbol shown at symbol position 624, rather than displaying the pay table for the “Treasure Chest” in addition to the “9” and “Wolf” symbols, the processor 204 may implement a method to choose between pay table information. For example, the processor 204 may apply a hierarchical selection model where the highest priority is to pay table information related to winning combinations that are paid, and the second highest priority is a size of a pay amount that would have been won for one additional symbol. In other examples, a different hierarchy could be applied by processor 204 such as a number of symbols displayed. In other examples, an alternative process may be used, for example, the processor 204 may store information in memory 208 as to how many games have occurred since pay table information has been presented about a specific symbol, and when selecting between two or more items of pay table information, the processor 204 may be configured to choose the information that has the higher number of games since last being presented.

A technical effect of presenting contextually relevant information is that it assists the player to obtain a greater understanding of the available pays for gaming machine relative to conventional approaches such as highlighting the winning combination and animating an increment to a win meter. In particular, presenting contextual information other than the winning amount assists the player to understand how variations to the selected symbols in symbol positions could have varied the amount of pays, or whether there were any pays.

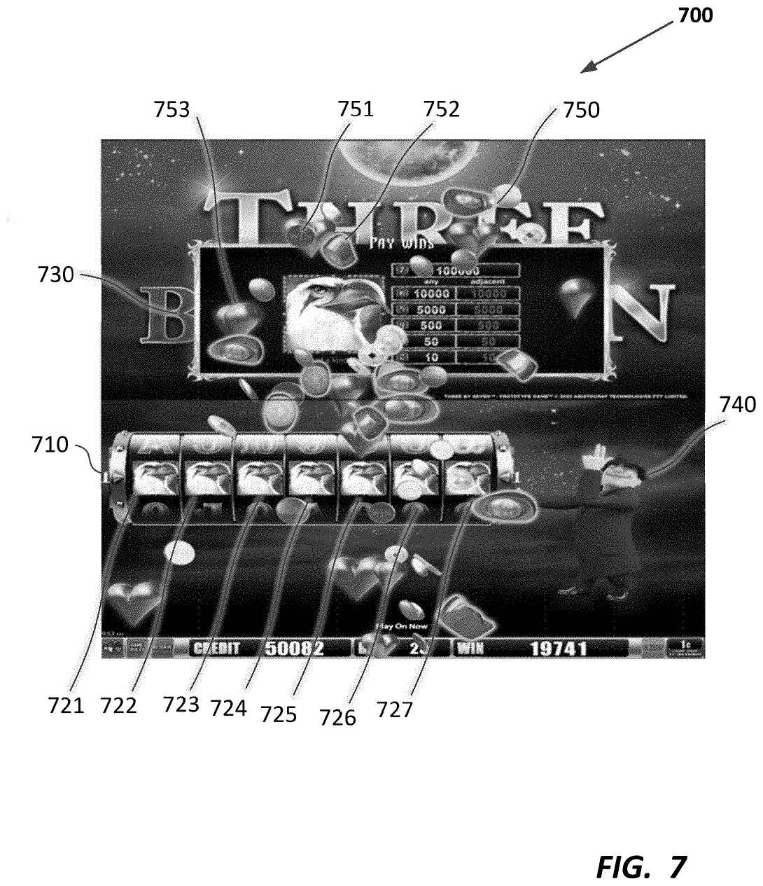

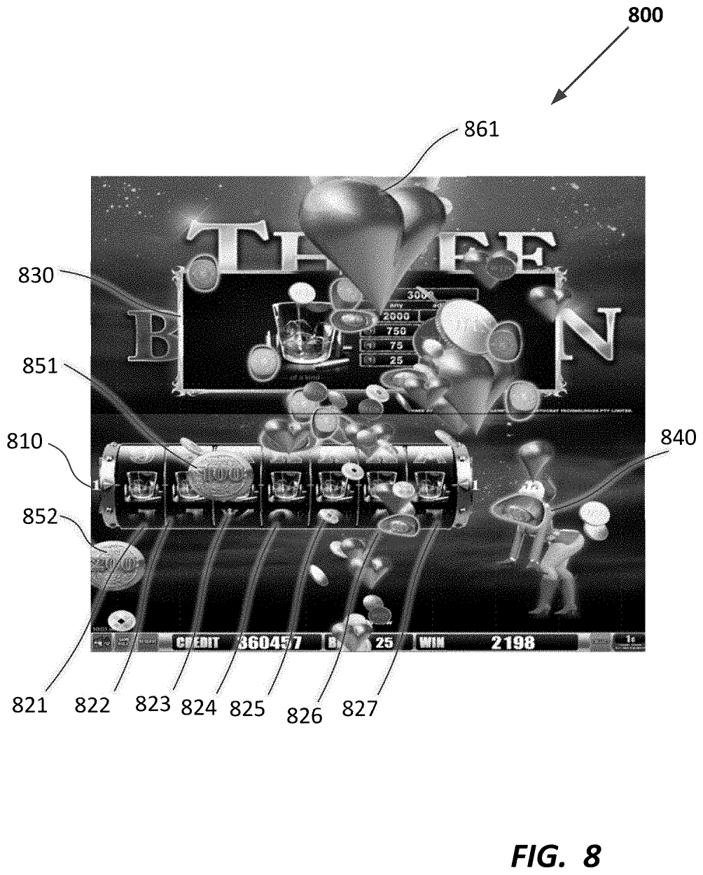

FIGS. 7 and 8 incorporate additional examples of dynamic pay table displays 730, 830. As both FIGS. 7 and 8 illustrate examples where a maximum seven of a same symbol have been selected only the pay table information for that symbol is presented as there are no other symbols for which contextually relevant information can be presented.

FIGS. 7 and 8 also illustrate examples of animations that can accompany specific winning outcomes, in this example, seven-of-a-kind winning outcomes. In this example, an animated character 740, 840 enters the display 700, 800 and is animated as pushing the selected symbols out of the way in a manner that makes the symbol positions 721-727, 821-827 reduce in size in order to create space for the animated character 740, 840 to be animated in a way that celebrates the win.

FIGS. 7 and 8 also illustrate a win celebration graphic in the form of animated objects 750 superimposed over other game image elements on the display related to generation of the game outcome that lead to win celebration graphic being triggered. In the examples illustrated in FIGS. 7 and 8, the objects are either coins 751, ingots 752, or hearts 753. Other examples may use other objects such as bank notes or nuggets. In the examples, one or more of the objects has a function, which can include representing a value that is to be added to the win meter in addition to the win amount of the winning outcome that is celebrated by the win celebration 750. (That is, in this case, the function of objects carrying values is to indicate the additional award to be added to the win meter.) In some examples, one or more of the objects has a function in each win celebration. In some examples, the processor 204 may monitor for interaction by a player with the objects before revealing the function of the one or more objects (e.g., the processor 204 may monitor for a touch input via the display that is in a region of display currently occupied by an object and which hence indicates that the player has touched an object or objects).

FIG. 8 illustrates an example of the result of an interaction where processor 204 has determined that a player has touched an object. In this respect, it will be observed that display of the heart object 861 has been changed so that it is enlarged relative to the smaller-sized heart objects shown in FIG. 8. In other examples, processor 204 may increase an object in size after a defined time period. In other examples, the display of object can be changed in other ways such as by changing color, causing the object to “explode,” or causing the object reveal whether it is associated with a prize.

FIG. 8 also illustrates an example where objects 851 and 852 carry values of 100 and 200 credits, respectively, which represent awards in addition to the award of 3000 credits for the seven glass symbols on win line 810. In some examples, the objects 851, 852 appear after a defined time or in response to a player action such as touching the display.

In some examples, processor 204 may employ RNG 212 to determine a number of coins having values and/or values on the coins, or may first determine an overall prize amount and then determine how to assign the prize amount to coins (or other objects). In an example, the processor 204 uses RNG 212 to randomly select between a plurality of outcomes stored in memory 208 that specify the value of the prize and the values of coins that are to be displayed. In another example, the processor 204 may add values to the objects based on an amount of the win being celebrated. For example, the win celebration may be triggered by a celebration condition such as by wins of a certain category (e.g., 7 of a kind) or wins above a threshold (e.g., 2000 credits), and the processor may add values based on a win amount, for example, 5%, 10% or 15% of the amount of the win that is being celebrated.

In other examples, the value on the object may be different such as an award of a feature game (or re-award of a feature where the win celebration is in a feature game), an award that multiplies the win value (e.g., doubles or triples the win amount), or lead to separate game play such as the character 740, 840 taking the coin and being animated as inserting it into a spinning reel game such as a three-reel game from which a prize may be awarded.

In other examples, the processor 204 may use RNG 212 to determine a number of special objects (e.g., coins) to appear in the win celebration. If at least a defined number of special objects (objects with a defined characteristic) are selected, an additional award is made. For example, 5 special coins wins a progressive prize. In some examples, a player may be required to interact with objects in order to win the prize. For example, the player may need to touch objects and reveal a defined number of special objects to win a prize. For example, the player may be required to touch special coins. Depending on the implementation, this can be a skill feature and/or a fun feature, the difference being that in a fun feature, the player's action does not affect whether or not a prize is awarded.

A technical effect of the disclosure is to provide additional game play functionality during a win celebration that, in some examples, involves additional interaction by the player.

Approaches described herein address technical problems of allowing a player to select whether and when to apply objects after RNG-based outcome determination in an electronic gaming device. By combining skill-based interactions with RNG-based aspects, this gameplay mechanic increases user engagement with the electronic gaming device. In particular, by providing a way to interact with objects after RNG-based outcome determination, the gameplay mechanic provides the player some control over how an outcome is rendered and/or supplemented. This can improve the usability of electronic gaming devices by enhancing the user experience for players, extending player time on the electronic gaming devices, and maintaining the interest of current players in the electronic gaming devices. In terms of system architecture, innovative features described herein provide a way to account for skill-based interactions in an architecture that otherwise only permits RNG-based functionality (such as a traditional Class III architecture). For example, whereas a traditional processing pipeline calculates the positions at which RNG-based reels are going to be stopped in the future, a processing pipeline according to an improved architecture also accounts for interactions with objects by the player. More generally, in terms of technical effects, innovative features of object interaction represent improvements in the technical area of electronic gaming software and provide new technology, in that they provide a simple and intuitive gameplay mechanic that provides the player some control over how an outcome is rendered and/or supplemented. At the same time, game play can be kept fair and consistent with regulations. These embodiments are thus not merely new game rules or new display patterns.

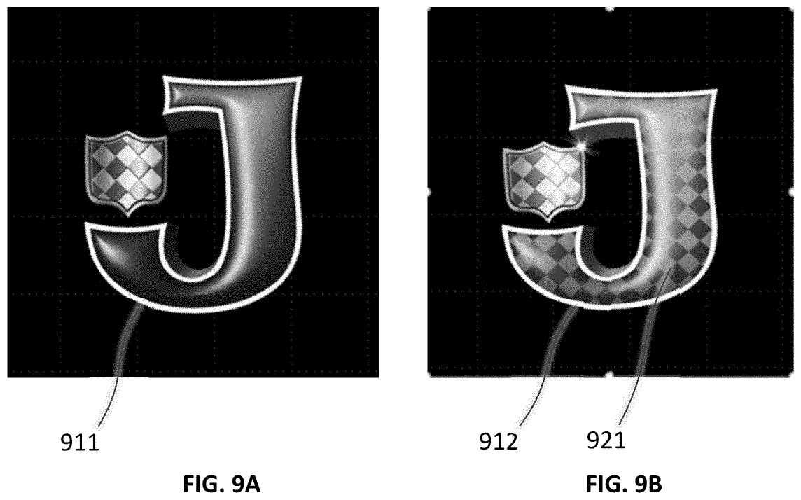

FIGS. 9 to 12 illustrate some example animations that are incorporated into the user interface of the EGM 200. The animations can be triggered by a change of state of the gaming machine and/or by a trigger event occurring during play of a game.

FIGS. 9A and 9B illustrate first 911 and second 912 animation states of a Jack symbol. In the first state 911, the Jack symbol has a solid color whereas in a second state 912 diagonal checks 921 are added to the Jack. In some examples, the change between the two states is animated such that the Jack symbol cycles between the first 911 and second 912 states. In some examples, the animation may be triggered by a state of the EGM, such as by processor 204 entering the EGM into an idle or attract state after a defined time period during which the EGM has not been played.

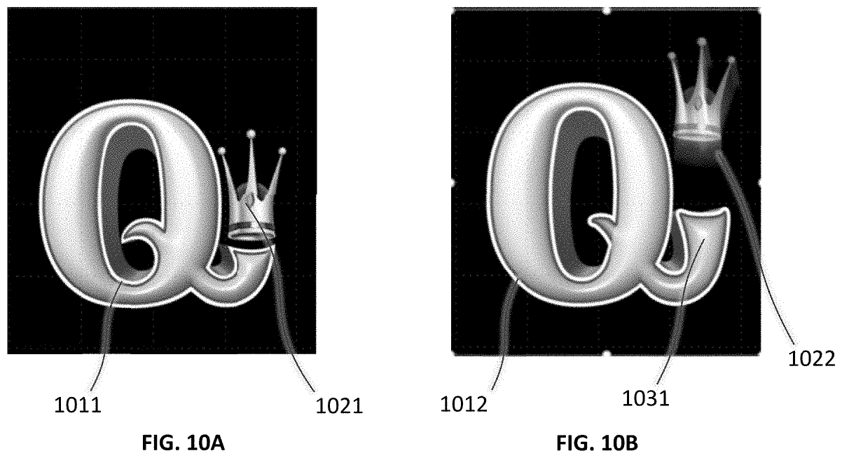

FIGS. 10A and 10B illustrate first 1011 and second 1012 animation states of a Queen symbol. In the first state 1011, a crown 1021 rests on the tail of the letter Q whereas in a second state 1012, the crown is displaced at a second position 1022 vertically above the tail of the letter Q. The change between the two states 1011,1012 is animated so as to show the tail of the letter Q throwing the crown from lower position 1021 to upper position 1022. Part of this animation can be observed by a side-by-side comparison of FIGS. 10A and 10B, from which it will be observed that the letter Q is higher in the second state 1012 and that the tail is larger 1031 to indicate vertical movement by the animation to throw the crown upwards. In some examples, the animation may be triggered by a state of the EGM, such as by processor 204 entering the EGM into an idle or attract state after a defined time period during which the EGM has not been played.

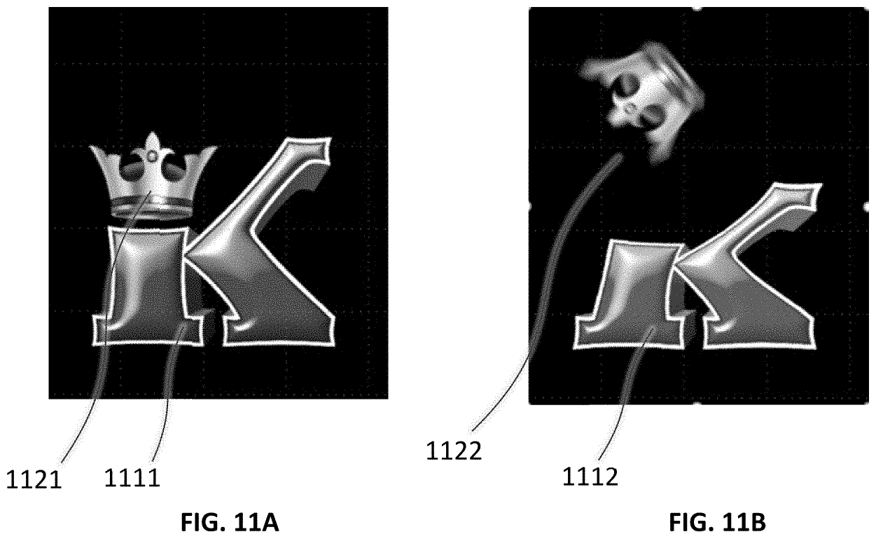

FIGS. 11A and 11B illustrate first 1111 and second 1112 animation states of a King symbol. In the first state 1111, a crown 1121 forms part of the letter K whereas in a second state 1112, the crown is displaced vertically upwards to a second position 1122 with a spinning animation. The change between the two states 1111,1112 is animated so as to show the crown being displaced upwardly with a spinning action. Part of this animation can be observed by a side-by-side comparison of FIGS. 11A and 11B, from which it will be observed that the letter K is flexed in the second state 1112 to indicate that it has flexed in order to throw the crown upwards while applying spin to the crown. In some examples, the animation may be triggered by a state of the EGM, such as by processor 204 entering the EGM into an idle or attract state after a defined time period during which the EGM has not been played.

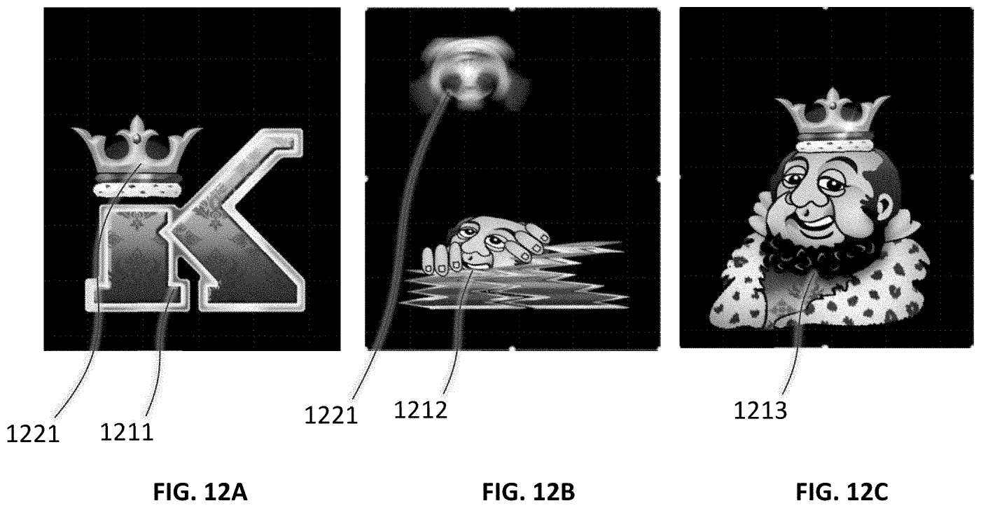

FIGS. 12A,12B and 12C illustrate an animation between two different king symbol states 1211, 1213: a first, letter-based king symbol state 1211 where a crown 1221 forms part of the letter K, and a second, character-based king symbol state 1213. (While symbol states 1221, 1223 could also be described as two different symbols, they are referred to as being two states of the king symbol as they retain the same functionality within the play of the game on the EGM.) During a transition animation state as shown in FIG. 12B, the crown 1221 is displaced vertically upwards to a second position 1212 with a spinning animation in a manner similar to FIGS. 11A and 11B. At the same time, the king 1212 appears from behind the letter K and is animated as squashing the letter K in order to move it out of the way. The crown 1221 subsequently lands on the head of the king to complete the character-based symbol state 1223.

The change between the two symbols 1211, 1213 is dependent on a trigger within a game played on the EGM, in this case, the occurrence of a winning symbol combination featuring the King symbol.

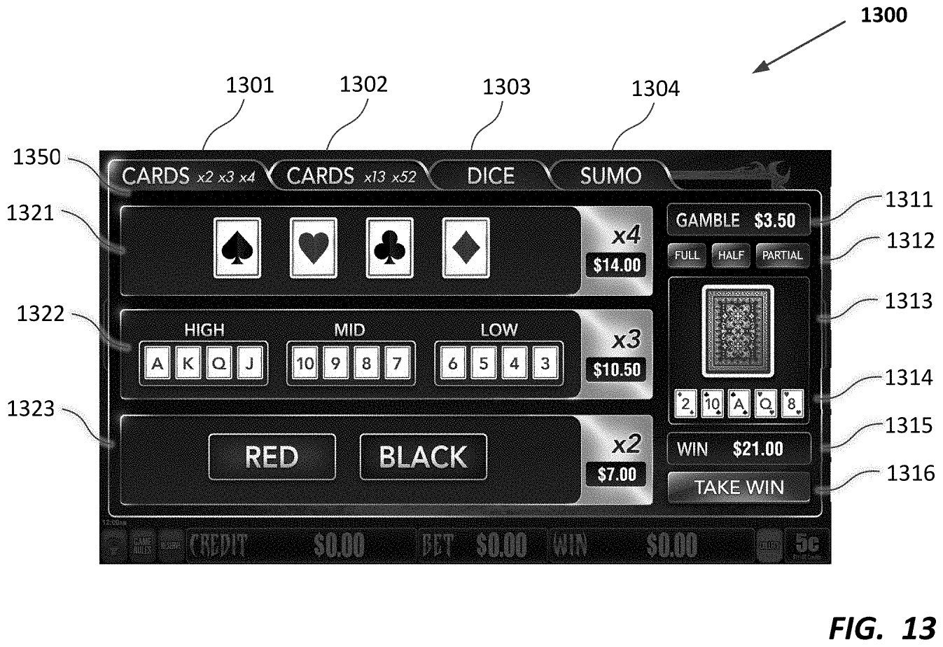

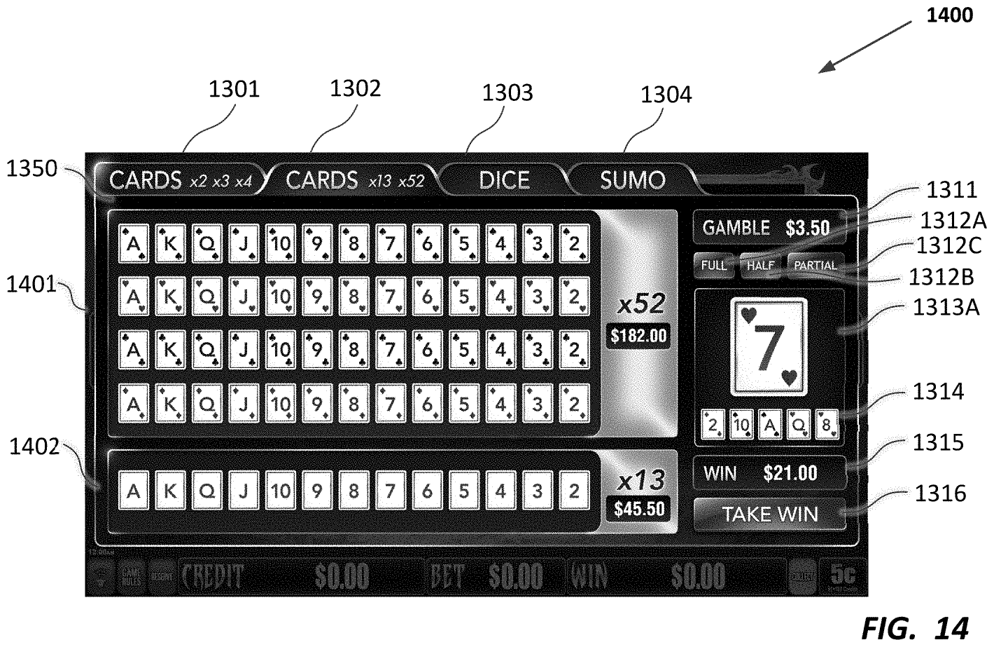

FIGS. 13 and 14 illustrate a user interface 1350 for an EGM for a gamble feature implemented by the processor 204 on the EGM. Many existing EGMs include a gamble feature that enables a player to wager the entire amount that they have won on a game outcome before the amount is transferred from the win meter to the credit meter. As shown in example screen displays 1300, 1400, the gamble feature user interface 1350 of the disclosure incorporates a plurality of user interface components including a plurality of tabbed screens 1301-1304 (“tabs”) to enable presentation via the gamble feature user interface 1350 of a wide range of options having different odds and/or different mechanisms for deciding the outcome of the gamble feature. In an example, the gamble feature user interface is launchable after a winning game outcome either automatically by processor 204 or in response to a user input such as interacting with a gamble button (not shown).

As shown in FIGS. 13 and 14, to the right of the tabs, the user interface 1350 displays a current gamble amount 1311. User interface incorporates a plurality of bet selection buttons 1312, specifically a full amount button 1312A that enables a player to select to wager the entirety of a current win amount 1315, a half amount button 1312B that enables a player to select to wager half the current win amount 1315, and partial amount button 1312C that results in the processor 204 controlling the display 240 to display a pop-up menu (not shown) that enables the player to enter a partial wager. In an example, the pop-up menu includes a slider bar for choosing a proportion of the current win amount 1315. In another example, the pop-up menu includes a virtual numeric keypad for entering a gamble amount. In this example, the player has interacted with the user interface 1350 to specify that they want to gamble $3.50 (i.e., one sixth of win amount 1315).

The user interface also includes a take win button 1316 that enables the player to elect to transfer the win amount to the credit meter. User interface also includes an outcome area 1313 that has a card face down to indicate that the gamble has not been initiated. Outcome area 1313 also displays the last five card selections 1314.

In FIG. 13, tab 1301 is active which corresponds to three gamble options 1321,1322, 1323 having a x4, x3 and x2 return respectively. The first gamble option 1321 of user interface 1350 enables the player to select one of the card suits by touching the icon corresponding to the respective suit in order to win four times the gambled amount. (In this example, $14.00).

The second gamble option 1322 of user interface 1350 enables the player to select from one of three different subsets of the cards by touching the respective subset. The player can win three times the gambled amount, i.e., $10.50.

The third gamble option 1323 of user interface 1350 enables the player to select red or black cards and hence win twice the gambled amount ($7.00).

In FIG. 14, tab 1302 is active which corresponds to two gamble options 1401,1410 having a x52 and x13 return respectively. It will be observed that in the screen display 1400, outcome display 1313A has just been updated to reflect that the 7 of Hearts has just been selected as the outcome of the gamble option.

The fourth gamble option 1401 of user interface 1350 enables a player to select an individual card and hence potentially win fifty-two times the gambled amount ($182.00).

The fifth gamble option 1402 of user interface 1350 enables a player to select a card independently of the suit and enables the player to win thirteen times the gamble amount ($45.50).

The third tab 1303 (not shown) of user interface 1350 incorporates other gamble options based on dice games. The fourth tab 1304 (not shown) of user interface 1350 incorporates other gamble options based on the game of Sumo.

Technical effects of the gamble feature user interface 1350 include that a player can select between a larger number of gamble option by virtue of the tab structure of the interface. Further, the player can select a desired amount to wager. The user interface 1350 thus enables the player to build a wide variety of gamble wagers of varying risk and volatility.

### EXAMPLE EMBODIMENTS

In an example embodiment, there is provided a gaming device comprising:

a display;

a credit input mechanism operable to establish credits on the gaming machine;

meters configured for monitoring credits established via the credit input mechanism and changes to the established credits due to play of the gaming machine;

a random number generator;

a player input for operation by a player to input a wager from the established credits and to initiate a play of a game;

memory storing game program code; and

a processor, the processor configured for executing the game program code stored in the memory responsive to initiation of the play of the game by player input to:
initiate a win celebration in response to a celebration condition being met; and
control the display during the win celebration by displaying an animation of a plurality of objects superimposed on underlying game image elements, wherein, in at least some win celebrations, at least one of the objects is associated with a function to be carried out by the processor.

In an example embodiment, the display is a touch screen display and the function is carried out by the processor after detecting an interaction with the object via the touch screen display.

In an example embodiment, the function is carried out by the processor after the at least one object is displayed.

In an example embodiment, the function is to change display of the object.

In an example embodiment, the function is to indicate an award of a prize amount additional to a win amount associated with the celebration condition.

In an example embodiment, the function is to generate an additional game outcome using the random number generator.

In an example embodiment, the function is to generate an additional game outcome using the random number generator if the animated objects include at least a defined number of objects with a defined characteristic.

In an example embodiment, there is a method of operating a gaming device comprising a display, a credit input mechanism operable to establish credits on the gaming machine, meters configured for monitoring credits established via the credit input mechanism and changes to the established credits due to play of the gaming machine, a random number generator, a player input for operation by a player to input a wager from the established credits and to initiate a play of a game, and a processor, the method comprising:

initiating, by the processor, a win celebration in response to a celebration condition being met; and

controlling, by the processor, the display during the win celebration to display an animation of a plurality of objects superimposed on underlying game image elements, wherein, in at least some win celebrations, at least one of the objects is associated with a function to be carried out by the processor.

In an example embodiment, the display is a touch screen display, and the method comprises performing, by the processor, the function after detecting an interaction with the object via the touch screen display.

In an example embodiment, the function is carried out by the processor after the at least one object is displayed.

In an example embodiment, performing the function comprises, by the processor, changing display of the object.

In an example embodiment, performing the function comprises indicating an award of a prize amount additional to a win amount associated with the celebration condition.

In an example embodiment, performing the function comprises generating an additional game outcome using the random number generator.

In an example embodiment, performing the function comprises generating an additional game outcome using the random number generator if the animated objects include at least a defined number of objects with a defined characteristic.

In an example embodiment, there is provided a gaming device with a dynamic pay table.

In an example embodiment, there is provided a gaming device comprising:

a display;

a credit input mechanism operable to establish credits on the gaming machine;

meters configured for monitoring credits established via the credit input mechanism and changes to the established credits due to play of the gaming machine;

a random number generator;

a player input for operation by a player to input a wager from the established credits and to initiate a play of a game;

a processor; and

memory storing game program code, game symbols, and pay table information defining winning combinations of game symbols;

the processor executing the game program code stored in the memory and responsive to initiation of the play of the game with player input to:
generate a game outcome comprising a plurality of game symbols using the random number generator;
control the display to display the game symbols of the game outcome;
evaluate the game outcome using the pay table information, and upon the game symbols of the game outcome including a winning combination of game symbols, make an award based on the pay table; and
control the display to display contextually relevant pay table information.

In an example embodiment, when the processor executes the game program code, it causes the processor to display contextually relevant pay table information including information related to at least one non-winning symbol combination based on the game outcome including part of a winning combination of symbols.

In an example embodiment, part of a non-winning symbol combination is one fewer symbol that required to form a winning combination of symbols.

In an example embodiment, when the processor executes the game program code, it causes the processor to display contextually relevant pay table information including information related to other potential winning symbol combinations featuring based on the same symbols of a winning symbol combination included in the game outcome.

In an example embodiment, there is provided a gamble feature user interface for a gaming device.

In an example embodiment, there is provided a gaming device comprising:

a display;

a credit input mechanism operable to establish credits on the gaming machine;

meters configured for monitoring credits established via the credit input mechanism and changes to the established credits due to play of the gaming machine;

a random number generator;

a player input for operation by a player to input a wager from the established credits and to initiate a play of a game;

a processor; and

memory storing game program code;

the processor executing the game program code stored in the memory and responsive to initiation of the play of the game with player input to:
generate a game outcome comprising a plurality of game symbols using the random number generator;
evaluate the game outcome for winning game outcomes and make an award responsive to the game outcome;
launch a gamble user interface subsequent to a winning game outcome (for example, automatically or responsive to a user input), wherein the gamble interface includes an interface component that enables a user to select a portion of the award to wager in a gamble feature.

In an example embodiment, there is provided a gaming device comprising:

a display;

a credit input mechanism operable to establish credits on the gaming machine;

meters configured for monitoring credits established via the credit input mechanism and changes to the established credits due to play of the gaming machine;

a random number generator;

a player input for operation by a player to input a wager from the established credits and to initiate a play of a game;

a processor; and

memory storing game program code;

the processor executing the game program code stored in the memory and responsive to initiation of the play of the game with player input to:
generate a game outcome comprising a plurality of game symbols using the random number generator;
evaluate the game outcome for winning game outcomes and make an award responsive to the game outcome;
launch a gamble user interface subsequent to a winning game outcome (for example, automatically or responsive to a user input), wherein the gamble interface includes a plurality of selectable tabs, each tab including at least one different gamble option, and wherein the selectable gamble options include a plurality of gamble options having different odds.

While the invention has been described with respect to the figures, it will be appreciated that many modifications and changes may be made by those skilled in the art without departing from the spirit of the invention. In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

What is claimed is:

1. A computer system comprising one or more processors and memory, the memory storing program code which, when executed, causes the one or more processors to perform operations to provide a skill-based interaction mechanism in an electronic gaming device having a display, the operations comprising:
receiving an indication of a wager amount;
decreasing a credit balance by the wager amount;
initiating a play of a game of the electronic gaming device;
based at least in part on results from a random number generator, determining an outcome of the game;
in response to a condition being met, initiating superimposition of multiple objects on underlying game image elements on the display of the electronic gaming device;
receiving indications of interaction with at least some of the multiple objects by a user; and
responsive to the indications of interaction, supplementing the outcome.

2. The computer system of claim 1, wherein the display is a touchscreen display, the indications of interaction are indications of selection of the at least some of the multiple objects by the user on the touchscreen display, and the underlying game image elements include symbols on reel strips.

3. The computer system of claim 1, wherein a given object of the multiple objects is associated with a function to be carried out by the one or more processors upon interaction with the given object by the user.

4. The computer system of claim 3, wherein the function includes generating an additional outcome of the game using the random number generator, and wherein the operations further comprise, upon interaction with the given object by the user, generating the additional outcome of the game using the random number generator.

5. The computer system of claim 3, wherein the function includes generating an additional outcome of the game using the random number generator if the at least some of the multiple objects include at least a defined number of objects with a defined characteristic, and wherein the operations further comprise, upon interaction with the given object by the user:
determining whether the at least some of the multiple objects include at least the defined number of objects with the defined characteristic; and
responsive to the at least some of the multiple objects including at least the defined number of objects with the defined characteristic, generating the additional outcome of the game using the random number generator.

6. The computer system of claim 1, wherein the condition is whether at least a defined win amount has been awarded.

7. The computer system of claim 1, wherein the memory and the one or more processors are part of a server configured to communicate across a network with the electronic gaming device.

8. The computer system of claim 1, wherein the memory and the one or more processors are housed within the electronic gaming device.

9. The computer system of claim 8, further comprising:
a credit input mechanism operable to add credits to the credit balance;
one or more meters configured to monitor the credit balance and changes to the credit balance; and
a player input operable to input a wager to be taken from the credit balance and to initiate the play of the game.

10. The computer system of claim 1, wherein the supplementing the outcome includes adding one or more additional outcomes to the outcome, awarding a supplemental feature, or awarding a multiplier of the outcome, and wherein the operations further comprise increasing the credit balance according to the supplemented outcome.

11. A computer system comprising one or more processors and memory, the memory storing program code which, when executed, causes the one or more processors to perform operations to provide an interaction mechanism in an electronic gaming device having a touchscreen display, the operations comprising:
receiving user input that indicates a wager amount;
receiving user input to initiate a play of a reel game of the electronic gaming device, the reel game having a set of reels with associated reel strips, wherein a credit balance decreases by the wager amount;
spinning the reels of the reel game;
displaying an indication of an outcome of the reel game on the touchscreen display, wherein the outcome is based at least in part on results from a random number generator;
in response to a condition being met, superimposing multiple objects on underlying game image elements on the touchscreen display;
receiving user input, through the touchscreen display, that indicates selection of at least some of the multiple objects by a user; and
responsive to the selection of the at least some of the multiple objects, updating display of the multiple objects on the touchscreen display.

12. The computer system of claim 11, wherein a given object of the multiple objects is associated with a function to be carried out by the one or more processors upon selection of the given object by the user.

13. The computer system of claim 12, wherein the function includes changing display of the object, and wherein the operations further comprise, upon selection of the given object by the user, changing display of the object on the touchscreen display.

14. The computer system of claim 12, wherein the function includes displaying an indication of a prize amount in addition to a win amount associated with the condition, and wherein the operations further comprise, upon selection of the given object by the user, displaying on the touchscreen display the indication of the prize amount in addition to the win amount associated with the condition.

15. The computer system of claim 12, wherein the function includes displaying an indication of an additional outcome of the reel game, and wherein the operations further comprise, upon selection of the given object by the user, displaying the additional outcome of the reel game on the touchscreen display, the additional outcome having been generated using the random number generator.

16. The computer system of claim 11, further comprising:
a credit input mechanism operable to add credits to the credit balance;
one or more meters configured to monitor the credit balance and changes to the credit balance; and
a player input operable to input a wager to be taken from the credit balance and to initiate the play of the game.

17. In a computer system, a method of providing a skill-based interaction mechanism in an electronic gaming device having a touchscreen display, the method comprising:
receiving an indication of a wager amount;
decreasing a credit balance by the wager amount;
initiating a play of a game of the electronic gaming device;
based at least in part on results from a random number generator, determining an outcome of the game;
in response to a condition being met for the outcome, initiating superimposition of multiple objects on underlying game image elements on the touchscreen display, wherein a given object of the multiple objects is associated with a function to be carried out by the one or more processors upon selection of the given object by a user on the touchscreen display;
receiving indications of selection of at least some of the multiple objects by the user on the touchscreen display; and
responsive to the indications of selection, supplementing the outcome.

18. The method of claim 17, wherein the function includes generating an additional outcome of the game using the random number generator, and wherein the method further comprises, upon selection of the given object by the user on the touchscreen display, generating the additional outcome of the game using the random number generator.

19. The method of claim 17, wherein the function includes generating an additional outcome of the game using the random number generator if the at least some of the multiple objects include at least a defined number of objects with a defined characteristic, and wherein the method further comprises, upon selection of the given object by the user on the touchscreen display:
determining whether the at least some of the multiple objects include at least the defined number of objects with the defined characteristic; and
responsive to the at least some of the multiple objects including at least the defined number of objects with the defined characteristic, generating the additional outcome of the game using the random number generator.

20. The method of claim 17, wherein the supplementing the outcome includes adding one or more additional outcomes to the outcome, awarding a supplemental feature, or awarding a multiplier of the outcome, and wherein the method further comprises increasing the credit balance according to the supplemented outcome.
